(19) United States
(12) Patent Application Publication
(10) Pub. No.: US 2010/0257050 A1
(43) Pub. Date: Oct. 7, 2010

(54) SYSTEM AND METHOD FOR PERSONALIZED SERVICE

(76) Inventor: Seoung Lan Lee, Dae Jeon (KR)

Correspondence Address: SHERR & VAUGHN, PLLC, 620 HERNDON PARKWAY, SUITE 320, HERNDON, VA, 20170, US

(21) Appl. No.: 12/745,766

(22) PCT Filed: Jun. 18, 2008
(86) PCT No.: PCT/KR08/03429

§ 371 Date: Jun. 2, 2010

(30) Foreign Application Priority Data
Jul. 16, 2007 (KR) 10-2007-0071030
Sep. 18, 2007 (KR) 10-2007-0094470
Dec. 7, 2007 (KR) 10-2007-0126510

(51) Int. Cl. G06Q 30/00; G06Q 10/00

(52) U.S. Cl. 705/14.43; 705/14.52; 705/14.53; 705/14.54; 705/14.58; 705/14.64; 705/14.67

(57) ABSTRACT

This invention is in regard of the system and method providing an information such as a content or an advertisement and supplying the personalized service in more concrete ways. The first side of this invention provides the personalized service system equipped the customer terminal, which acquires the service providing server selecting the personalized information that is what the user will acquire; and acquire this selected personalized information in accordance of the correlation between the information specific code corresponding to each specific characters of information and personalized specific code corresponding to the character of user.

### TECHNICAL FIELD

Personalization service

### DISCLOSURE OF INVENTION

### Technical Problem

This invention is in regard of the system and method providing an information such as a content or an advertisement and supplying the personalized service in more concrete ways.

The information service and the marketing service provided through the conventional technology have a problem of giving the first consideration to the information provider, not the user. For example, A company's homepage, which provides the information about the health through the user-web terminal, the information that A company considers important will be placed on the homepage. Therefore, the user should move to the homepage and another linked page, or to the other page linked to another page to find the information that the user needs and such process takes too much time of user or makes the user tired. Also, for the information service and the marketing service provided through the conventional technology, the information provider does not deliver the information effectively to the person, who can actually use the value of the providing information.

### Technical Solution

Thus, the technical subject that this invention is intended to achieve, is to solve problems mentioned above and to provide the personalized service system and method, which can deliver the information that is beneficial and essential to the user or preferred by the user, to the user in the aspect of user.

Also, the technical subject that this invention is intended to achieve, is to supply a complicated information channel (media, important expense, site, membership, advertisement) forming overall life of the user's daily life and an intention-model channel (object-understanding relationship, decision making relationship, memory relationship, etc) as the self-centered, simple, convenient, important value (priority)-ordered personalized service system and method based on a long-term trust-building up through exhaustive integrating personalization.

Another technical subject is to provide the personalized service system and method, which can provide the personalized serviced to the user with an ample possibility for using the information in the aspect of the information provider (for example, the content provider or the advertisement provider).

### BRIEF DESCRIPTION OF THE DRAWINGS

FIG. 1 shows the personalized service system through the operating example of the invention

FIG. 2 shows the example of the service providing server(100) applied in the personalized service system in FIG. 1.

FIG. 3 shows the main terminal(300) or correlated terminal(400) applied in the personalized service system in FIG. 1.

FIG. 4 shows the method of personalized service through an operational example.

### MODE FOR THE INVENTION

This is a technical method to achieve the mentioned goal, the first side of this invention provides the personalized service system equipped the customer terminal, which acquires the service providing server selecting the personalized information that is what the user will acquire; and acquire this selected personalized information in accordance of the correlation between the information specific code corresponding to each specific characters of information and personalized specific code corresponding to the character of user.

Desirably, the service providing server selects stated above the personalized information in accordance of the correlation among informations which are included in user selecting information pool

Desirably, this personalized specific code mentioned above includes desirably the beneficial code, which corresponds to the benefits that the user acquired from the companies and the specific characters of related user.

This personalized specific code includes the types of information and related code. For instance, the type code stated above equips at least, one of the mental-habit developing code, the learning attitude developing code, the learning ability developing code, the religious belief strengthening code, the health care code, the financial technology code, the spare-time activity code, the life-essential information code, the discount advantage code, the company supply code and the individualized advertisement code. For instance, the type code mentioned can be set up by the user. For example, the type code can be changed according to response of the user of provided information.

The personalized specific code stated above includes the delivery code, which corresponds to the delivery of the information and specific characters of the user.

For instance, the personalized specific code have separate values for each time, location or the user terminals.

The service providing server selects desirably the information, which should be used in the correlation calculation according to the off-line code information that is acquired from the user terminal or an additional terminal.

The service providing server selects desirably the information, which should be used in the correlation calculation according to the on-line code information that is acquired from the user terminal or an additional terminal.

Desirably, this service providing server operates in accordance of the personalization configuration code (this personalization configuration code includes the configuration information at least one of the information pool, the personalized information providing condition and terminal), which is set up by the user. For example, this service providing server uses the information included in the information pool for the correlation calculation. For instance, this service providing server provides the personalization information to the user terminal, if the personalization information providing condition is satisfied. As an example, this service providing server provides the personalization information to corresponding user terminal that is the personalization information providing terminal. For example, this personalization configuration code is set up according to the off-line code information, acquired through the user terminal or an additional terminal. For instance, the information pool used by this service providing server is configured in accordance of the delivery scenario using at least one of delivery attributes of the basic delivery attribute, on-off line related delivery attribute, lapse of memory management delivery attribute, rule of 8020 delivery attribute, deterioration value decreasing delivery attribute, improvement value increasing delivery attribute, execution reinforcing delivery attribute, and information-made delivery attribute.

This service providing server operates desirably according to the personalization configuration code (this personalization configuration code includes the personal menu code, the delivery reliable code, the main correlated terminal code, the main application place code, the transmitting area limitation code, the transmitting time limitation code and the limit restriction code), which is set up by the user.

Desirably, these information includes the advertisement.

The second side of this invention provides the personalized service method, which fulfills (a) step, selecting the personalization information that will be provided to the user in accordance of correlation between the information specific code corresponding to each information and the personalized specific code corresponding the special character of the user; and (b) step, which will transmit such selected personalization information to the user terminal.

Desirably, in (a) step, this service providing server selects the personalization information according to the correlation of information included in the information pool that is selected by the user.

In (b) step, such selected personalization information is transmitted to the user's terminal through at least one of personalized menu delivery, off-line delivery, correlated delivery, store-made delivery and advertisement delivery.

Desirably, this personalized specific code includes benefits acquired from companies and the beneficial code corresponding to the characteristic of the user.

This personalized specific code includes the type-code, corresponding to the information types and the characteristic of the user. For example, this type-code includes at least one of the mental-habit developing code, the learning attitude developing code, the learning ability developing code, the religious belief strengthening code, the health care code, the financial technology code, the spare-time activity code, the life-essential information code, the discount advantage code, the company supply code and the individualized advertisement code. For instance, this type-code can be set up by the user. For example, the type code can be changed according to response of the user of provided information.

This personalized specific code includes the delivery code, which corresponds to the delivery of the information and specific characters of the user.

For instance, the personalized specific code have separate values for each time, location or the user terminals used in the step (b).

For instance, the personalized service method stated above includes another step (c) of selecting the information, that will be used in the correlation calculation of step (a) according to the off-line code information acquired from the user's terminal or an additional terminal.

For instance, the personalized service method stated above includes another step (c) of selecting the information, that will be used in the correlation calculation of step (a) according to the on-line code information acquired from the user's terminal or an additional terminal.

For instance, this personalized service method includes another step of setting up the personalization configuration code (this personalization configuration code includes at least one of the configuration information of the information pool, the personalized information providing condition and the personalized information providing terminal). For instance, (d) this includes additional step of selecting the configured information pool as the information, which will be used in the correlation calculation of step (a). For example, this (b) step will be performed only alter this personalized information providing condition is satisfied. For instance, in this (b) step, This personalized information will be provided to the user's terminal, which is this personalized information providing terminal. For example, This personalization configuration code is configured according to the off-line code information acquired from the user terminal or an additional terminal. For instance, this information pool used is configured in accordance of the delivery scenario using at least one of delivery attributes of the basic delivery attribute, on-off line related delivery attribute, lapse of memory management delivery attribute, rule of 8020 delivery attribute, deterioration value decreasing delivery attribute, improvement value increasing delivery attribute, execution reinforcing delivery attribute, and information-made delivery attribute.

For instance, this personalized service method includes another step (c) of the personalization configuration code (this personalization configuration code includes at least one of configuration information of the personal menu code, the delivery reliable code, the main correlated terminal code, the main application place code, the transmitting area limitation code, the transmitting time limitation code and the limit restriction code)

Desirably, these information include the advertisement and this personalized information includes the personalized advertisement. For instance, this personalized advertisement, which corresponds to the keyword searching, will be provided in order of higher correlation between the information specific code of this advertisement and the personalized specific code of the user. For instance, in providing this personalized advertisement, the advertisement commission will be graded according to application response of different individuals, who are provided with this personalized advertisement. For instance, in providing this personalized advertisement, the advertisement commission will be graded for each different phrases or expressions, used in the headline title.

For instance, this personalized method (c) includes a step of link registering the MAC household of correlated terminal and MAC address of wireless transmitter connected to the main terminal in the main application location for correlation of correlated terminal (the terminal where at least one of this main terminal and the correlated terminal is transmitted to the personalized information), placed in the main application location of the user and the main terminal that the user carries along.

The recent information service and the marketing service through the conventional technology has a hard structure to be out of denial (bad information, uneconomical information and environment the information without informational purpose, and information not promoted by the parents, etc), existed in traditional, as it is performed separately by the company and focused on the knowledge, comfort-made, spend a spare time, and interest just to make a benefit.

In this paper, we apply a scenario-type of delivery attribute to the information, which is provided to individual to make the best use of 24 hours integrated delivery management focusing on the long-term reliable, emotion and competitive power, recommended information of parent for each user with strength of personalized One-stop channel providing, correlated with the most familiar media for each user.

Desirably, For instance, the information pool is configured in accordance of the delivery scenario using at least one of delivery attributes of the basic delivery attribute, on-off line related delivery attribute, lapse of memory management delivery attribute, rule of 8020 delivery attribute and knowledge-focused delivery.

Desirably, the information pool used in this personalized service is configured at least one of delivery attribute of deterioration value decreasing delivery attribute, improvement value increasing delivery attribute, execution reinforcing delivery attribute, and information-made delivery attribute.

Also, this invention, in aspect of the first side, applies three kinds of personalized integrated management system of personalization integration for individuals to solve the technical problems stated above.

First of all, it is on-off line integrated infra personalized system, which provides personal menu per all medic (cell-phone, PC, IPTV, newspaper, book, etc), so that all ages from child to the aged can select the media that they are familiar with and apply to the co-relate that media to the cell-phone. Secondly, it is the integrated personalized management system, which can be set up the One-stop integrated channel gaining a long-term reliability, performs an integrated management of huge benefit focused on major expense per users and as its benefit, the users can set up according to their preference and select either charged information pool (pool: personalized delivery tool that is classified to the attribute and interested type through reference model classification per parts index classification) or, free information pool to use. Also, the user can set up and apply the application level of personalized advertisement that should be provided as a cost of benefit. Next, it is the system that manages the mental model per all managing targets and recognizing targets of each person for 24 hours, focused on individual emotion and competitive power. Mental model per target is destroyed or distorted because of lapse of memory or wrong mental habit and created through new recognition, therefore, to keep the mental model nicely for individual, the system integrates and manages 20% of good mental habits, which shows 80% effects in personalized lapse of memory management and rule of 8020 over the channel of these 2 types of integrated management mentioned above, using the information pool.

Thus, the service portal in accordance of the first side of this invention, can assure the user widely from child to an aged and also, it can provide more wider range of benefit and personalization to the user through easy cooperation with many companies all around the fields. Not only that, the service portal can easily confirm the personalization information, valued for wide range of whole life of individual and provide the integrated marketing channel, which enables the cooperated company to use the valued personalization information and the affiliated concern to transmit the sales of product or the marketing to the exact and higher like hood customer.

For the followings, we explain the real example of this invention referring to attached figures. However, the example of this invention can be changed into various forms and the range of this invention should not be interpreted to be limited within only the example explained below. These examples of this invention is provided to explain the invention more accurately to the user, who has a general knowledge in the technical area, where this invention belongs.

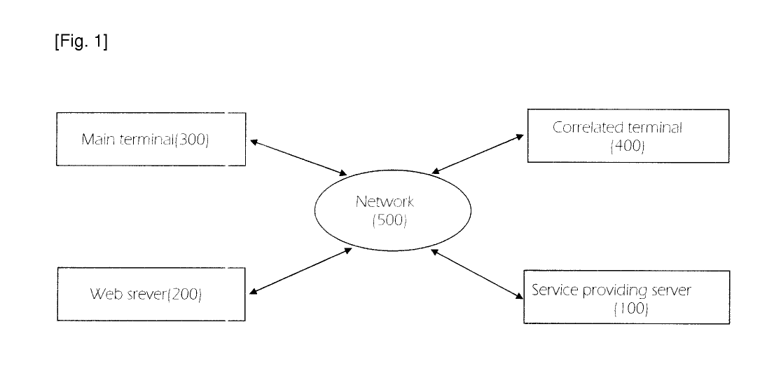

FIG. 1 shows the personalized service system through the operating example of the invention. Refer to FIG. 1, the personalized service system includes the service providing server(100), the web-server(200), the main terminal(300), the correlated terminal(400) and the network(500).

The service providing server(100) performs the function of selecting the personalized information (this can be called as the personalized advertisement, in case of the information is the advertisement), which is the information provided to the user according to the correlation between the personalized specific code and the information specific code, where the personalized specific code corresponds to the characteristic of the user and the information specific corresponds to the characteristic of the information provided by the information provider. A simple case of the personalized specific code, the information specific code and the [symbol] relation is expressed in the formula 1. These personalized specific code, information specific code and relation will be explained later in detail.

MathFigure 1

### [Math.1]

the personalized specific code related to disease:

[high blood pressure, diabetes, atopy, asthma, cancer fatness]=[1 0 1 1 0 0]
the information specific code related to disease:

[high blood pressure, diabetes, atopy, asthma, cancer fatness]=[0 0 1 1 1 0]

correlation=[1 0 1 1 0 0]T·[0 0 1 1 1 0]=2

In this formula, high blood pressure, diabetes, atopy, cancer, and fatness are elements of the personalized specific code or the information specific code, and 1 0 1 1 0 0 are values of the personalized specific code, 0 0 1 1 1 0 are values of the information specific code, and [ ]T refers to the transposed matrix of [ ], and · refers to the dot product.

The service providing server(100) can select the information (the information pool) that will be used in the correlation calculation according to the personalization configuration code (especially, the information pool or the personal menu, configured in the personalization configuration code), off-line code or on-line code. The personalization configuration code, off-line code or on-line code will be explained later in detail.

The service providing server(100) provides the personalized information according to the personalization configuration code (especially, the providing condition and terminal of personalized information configured in the personalization configuration code).

In the concrete, the service providing server(100) transmits personalized information to providing terminal when the providing condition is satisfied

The web-server(200) receives the information related to off-line code, on-line code, the personalization configuration code or the type code (type of the personalized specific code) from the main terminal(300) or the correlated terminal(400) and transmits this information to the service providing server(100). Also, the web-server(200) transmits the information received from the service providing server(100) to the main terminal(300) or the correlated terminal(400). In case of the agent program (not figured) is installed in the main terminal or the correlated terminal(400), the web-server(200) can be eliminated. In this case, the agent program supplies the information related to off-line code, on-line code, the personalization configuration code or the type code to the service providing server(100) and acquire the personalized information from the service providing server(100).

The main terminal(300) or the correlated terminal(400) receives the personalized information selected by the service providing server(100). The main terminal(300) or the correlated terminal(400) receives the information related to off-line code, on-line code, the personalization configuration code or the type code and transmits either directly to the service providing server(100) or through the web-server(200). The main terminal(300) is the terminal that the user carries mostly, and the correlated terminal(400) is the one that the user does not carry. Examples of the main terminal are the mobile, PDA (personal digital assistant), the smart-phone or the portable computer. The correlated terminal(400) can be PC (personal computer), IPTV (internet protocol television) or others.

The network(500) can be wired internet network or wireless internet network. Through the service providing server(100), web-server(200), main terminal(300), correlated terminal(400) and network(500), the information can be mutually exchanged. Naturally, the service providing server(100), web-server(200) can communicate directly without passing through and it makes no difference even if the service providing sever(100) and the web-server(200) are implemented in one physical server.

The Personalized Specific Code

The personalized specific code can include the beneficial code corresponding to the user's characteristic related to the benefit provided by companies (granted according to the product usage grade of company). For instance, the benefit can be the point score provided by the affiliated concerns. The beneficial code can be expressed like formula 2.

MathFigure 2

### [Math.2]

beneficial code:

[Card, finance, fund, education, telecommunication, shopping]=[9, 1, 4, 0, 1, 1]

In the formula stated above, 0 is the case where the point of target range is less than the first critical value, 1 is the case where the point of target range is in between the first critical value and the second critical value, 9 is the case where the point of target range is larger than the ninth critical value. If the beneficial code is used, the characteristic regarding expense of the user can be generalized and collected, managed simply. In case of example expressed in formula 2, it can be analyzed that the user has a higher card usage of target company and spends less money on the educational product of target institution.

An example of a scenario of personalized service with benefit is like following. First of all, after the affiliated companies set up the portal specialized in order of important expense of family, the user joins the communication product (the number transfer, new membership, combined product, etc) and the portal of this invention at the same time, then the affiliated companies provide new benefits to newly joined customer or to the customer, who conventionally uses the companies' product. Also, collect, integrate and provide the received miles or the cash-back to the user. Next, the user collects the benefits and uses the information pool that the user wants, in the information pool provided by the portal, reducing the benefit. The communication affiliated company provides the wireless internet, the wireless dual-phone, great integrated product benefit, special benefit for the family join to the best customer, newly joined or the number transferred customer with free-charge or benefit of some dollars. Also, the affiliated company in other areas, provide new benefit, transferring some of traditional benefit, or indirect marketing cost. The vehicle insurance provides a graded benefit of several dollars per month to the existing customer or newly joined customer, who makes pre-contract of next-year contract and the finance, back, fund, newspaper and others can provide a graded benefit of regular cost per month to their best customer or newly joined customer. Also, the card, shopping and others can provide a graded benefit of regular cost per month, and the tutorial institution can a graded benefit of regular cost per month to the student.

Besides, the benefits collected regularly can be used, selecting and setting the information pool that the user wants.

The personalized specific code can include the information type (for example, the type classified into the reference model, dividing the personal taste or interest of individual per each information pool of detail information classification, identified as all kinds of index) and related type code corresponds to the characteristic of the user. For example, the type code related to the financial technology can have same value with formula 3, as it is configured through the user interface.

MathFigure 3

### [Math.3]

the type code related to the financial technology information pool:

[Field 1 Field 2, basic property of investment, the supplying level]=[5, 2, 1, 3]

In this formula, 5 of field 1 is finance, 2 of field 2 is a real estate, the basic property of investment 1 is stable investment, the supplying level 3 refers to the information pool with the type code of medium level. The information type is similar to the classification that classifies the widget used in wired or wireless personalized service, but the difference is that the widget of reference modeling of interest and personal taste classification in one of sub-section's widget. The traditional wired or wireless widget configuration is performed via on-line, but in this invention, the widget configuration is provided through off-line code book (will be explained later) in phone-book or magazine form, providing more comfortable, easy and detailed personal menu function. Also, for simple configuration, an integrated type can be provided, combining several type attributes from on-line code book and off-line code book.

The type code can be changed according to response of the user. The user's response can be divided into several steps, a step, where the user does not check out the information from the personal menu of mobile, a step where the user checks out the information from the mobile, a step where the user wants more contents and sets up the correlation with other terminal after checking out from the mobile, a step where the user actually uses the information (for example, the user clicks the menu provided the corresponding information and moves to site, which provides more and detailed information and performs process such as membership join, etc). If the user continues to check out the finance related information, not the real estate related information from the provided financial technology as the personalized information, the type code related to the financial technology configured like formula 3 can be changed as formula 4.

MathFigure 4

### [Math.4]

the type code related to the financial technology information pool

[Field 1, Field 2, basic property of investment, the supplying level]=[5, 2, 1, 4]

In this formula, the information providing level 4 refers to the medium level of personalized information delivery focusing on the finance.

The type code can includes the mental-habit developing code, the learning attitude developing code, the learning ability developing code, the religious belief strengthening code, the health care code, the financial technology code, the spare-time activity code, the life-essential information code, the discount benefit code, the company supply code and the individualized advertisement code.
Mental-habit developing code: Code that corresponds to the characteristic of user related to the mental-habit developing about decreasing the aggravated value of factor X and Y, increasing the elevated value of factor X and Y, or increasing executive ability, etc. Detail codes are a generation code (teens, 20, 30, 40, 50, etc), delivery item (factor X oriented, factor Y oriented, factor-X-oriented for decreasing the aggravated value of factor X, factor-Y-oriented for decreasing the aggravated value of factor Y, etc), innateness ability (blood type, physical constitution, character pattern inspection of MBTI)
Learning attitude developing code: Code that corresponds to the characteristic of user related to the learning attitude developing. Detail codes are an academic grade code and a learning attitude developing (strengthening confidence, strengthening patience, strengthening concentration, strengthening initiativeness, strengthening enjoyment, etc)
Learning ability developing code: Code that corresponds to the characteristic of user related to the learning ability developing. Detail codes are an academic grade code, the learning ability code (strengthening logic ability, strengthening analysis ability, strengthening memory ability, strengthening insight ability, etc) and learning ability supporting code (english, science, reading, etc)

The execution example of service method for the learning ability developing is as follow.

Specific Process 1: According to the personalized specific code (personalization configuration code) and personally studying-related information pool, before taking lessons, personally on-off related personalization studying course about personally pre-studying contents can be delivered, therefore this process can be supported with prior consideration, forgetting management, and reflexive insight broadening.

Specific Process 2: It is mentioned as a process that on the following contents of either on-line or off-line learning, specific details of studying patterns provided with personally learning-related personalization code basis given by the topics of main studying contents, questions, reflexive recognization, thinking differently, and creating ideas should be submitted on-line or taken the images by mobile phone and hand them in after documenting off-line studying details,

Specific process 3: This process is mentioned as a certified process that co-relates with personalization information according to personal taste, when studying the contents of textbooks with utilization of off-line coherent code included in the off-line textbook that related with the personally given classes.

Specific 4: It is mentioned as the feedback process that within two days of specific 2 process, self-documented file as the second forgetting management and superior data of his or her friend, and teacher's comment can be provided according to individual personalization code, therefore, submitted specific details can be reanalyzed, verified with new perspective, and provided according to personal taste, thereby performing comparison with other ideas, which had been designed in order to obtain effective learning-benefits including thinking differently, broadening insight, multi-dimensional reflection learning. Based on this process, these can be utilized on the advanced personalization development.
Health care code: Code that corresponds to the characteristic of user related to the health care. Detail codes are a generation code, basic health code, genetic and innate disease code, health care habit code, medical treatment habit code, etc.

basic health code contains physical constitution, blood type, height, etc. genetic and innate disease code contains hypertension, diabetics, cancer, and asthma, or habitual disease including smoking, addiction to drugs, and obesity. health care habit code contains eating habit, exercising habit, mental habit, etc. medical treatment habit code contains physical health training, acupuncture, massage, yoga, etc.

In the treatment case of the inveterate disease, If the treatment is performed by doctor's comment, the remedial effects can vary from personal taste to the surroundings, however, by this contrivance, personalization management is done with medical expert's care including prior management, close management channel for twenty-four hours, and management methods, and recognization methods, therefore effective and convenient management can be done with diversified personalization management,
Religious belief strengthening code: Code that corresponds to the characteristic of user related to the religious belief. Detail codes are the religious belief classification code, message delivery classification code (preaching oriented, message oriented, etc.), mento code (specific preacher, specific religious group, etc.)
Financial technology code: Code that corresponds to the characteristic of user related to the financial technology. Detail codes are the type of financial technology code, investment inclination code or financial information delivery level code, etc. type of financial technology code contain insurance, stock, fund, estate, saving, etc. investment inclination code contain conservative, the middle path, positive, consultant recommending, etc. financial information delivery level code contain beginner grade, intermediate grade, high grade, etc.
Leisure usage code: Code that corresponds to the characteristic of user related to the leisure usage. Detail codes are generation classification code, leisure usage code (game, TV, music, UCC, blog, etc.)
Living essentiality information code: Code that corresponds to the characteristic of user related to the living essentiality information. Detail codes are generation classification code, living essentiality information code (living law, health, medical treatment, common sense, education, finance, culture, etc.), living essentiality information delivery level code, etc.
Discount benefit code: Code that corresponds to the characteristic of user related to the discount benefit. Detail codes are the address code, the payment code, the discount area code or the discount specific code and examples of elements of this payment code are monthly payment (free, 5000 won, 10000 won, 50000 won, etc), special period payment code (once, 1 week, 3 months, 6 months, etc). Elements of discount area code are hotel, condo, local food, club, on-line product, entertainment, leisure, or shopping and elements of discount specific code are small amount benefit, local benefit or area-related benefit (health, shopping, hotel, food-service, entertainment, etc).
Company supply code: Code, which corresponds to the characteristic of user related to the company supply. Detail codes are, the position code, the personal competitive area code, the duty competitive area code or the specialized information code. Elements of position code can include clerk, assistant manager, acting manager, department manager, director and representative. Elements of personal competitive area code are passion-strengthening, insight strengthening, creativity strengthening, and others. Elements of duty competitive area are competitive power strengthening information regarding development, production, marketing and others. Elements of specialized information code are those classified according to the detail index of company specialized portal.

As an example of personalized service method of company market, joining the portal of this invention to provide tool of personal competitive power, family-support competitive power, duty competitive power, principle of company strengthening and work efficiency to the employees per company, enables the personalized application of all kinds of company information pool within the range that the company allows for target employees. This will be applied, setting up the providing scenario and menu per individual in classification of the main application location (within the company, house, etc) related to personal market personalized service and individuals.
Free information code: Code that is corresponding to the characteristic of user related to the free information. This is about free personalized information provided for pre-supplying purpose to indicate the direction of pre-product development, introducing and selling their product, and making profits of personalized advertisement through visiting their site and detail codes are the household classification, the information division code, the information level code and others. Elements of information classification code are classifications such as an general index. Elements of information level code are profession level, application level and others.
Personalized advertisement code: Code, which corresponds to the characteristic of user related to personalized advertisement to grant personalization property of advertisement per individual using exclusive channel and non-exclusive channel. Exclusive channel is the advertisement channel provided with charged information and non-exclusive channel is the one provided with free-charged information. In detail, the exclusive channel refers to the integrated marketing channel provided in a way of exclusive form per individual by the affiliated concern, combined with charged-information via the support of the company. This delivers personalized advertisement information of support, image-advertisement, custom-management information per each customer (important decision making of product management, monthly spending, benefit information, payment result, etc). In case of using one personalization tool with several benefits, it has the personalized delivery in order of supporting rate. Non-exclusive channel is the integrated marketing channel, providing personalized in a way of non-exclusive form per individual combined with free-charged information. This can set up the providing advertisement area, which should deliver a specific number personalized advertisement for a day. Detail codes are structured with classification of index-type or reference model form related to personalized advertisement area.

As an example of personalized advertisement delivery service method, not like personalized advertisement through keyword searching in mobile or other terminal, it is the system, where the advertiser provides personalized advertisement to the customer, who has the personalized specific code corresponds to the information specific code of the advertisement. This is a personalized searching method through correlation calculation of the personalized specific code and the information specific code, applying the personalization code system of this invention, for searching with inserted keyword or the reference model. This is not the personalization type of showing the advertisement in order of higher bidding price of advertiser, but is the personalization advertisement system providing the advertisement in order of higher correlation with the personalized specific code of customer. Also, the customer, who will be provided with the advertisement can be estimated according to the personalized code of user involved in the portal. For instance, select 3040 household from the household classification, select the specialized benefit target from the insurance benefit code, the specialized benefit target from the card benefit code and select the target who uses a specialized tool from the charged personalization tool and likewise, select the target code, which fits the company's advertisement and performs the personalized advertisement. Also, as an example of make a profit through the non-exclusive channel personalized advertisement, the method is for the advertiser to make a profit referencing the application response, type of correlated personalized advertisement, content, correlated application information (commission is graded according to detail application level such as the level of mobile usage, application level in PC or IPTV). Also, keep the application reliability of customer via the system of reducing the commission of the personalized advertisement with higher application response. Another example of making a profit applied to the personalized advertisement is to grade and apply the commission according to the delivered personalized advertisement or the individual application response of application response.

Response valuation can be performed with a step of checking the contents via the title of headline on the screen of mobile, a step of moving to a page related to the contents of headline information through mobile, a step of checking the related content in the target site through PC or IPTV combined with other media to check out details of content regarding the personalized information and a step of not checking the subject of headline through mobile at all. The response can also be valuated through the miles or points, in case of person inserting the response according to the provided form.

Also, deliver a periodic application improving report per each reference model for each customer to learn the application improving method, so that the usability of personalized information can be improved.

For another instance, the service method is the personalized information service method, using a phase, term, expression that will be used in the headline title showing on the personalized menu of customer in the information delivery such as the personalized information and the personalized advertisement, so that the customer can recognize the content, keeping the delivery reliability. This is the method providing the standard of judgment whether to select and open the content delivered to the personalized menu or ignore it. Conventional keyword searching grades the commission, paid by the information provider in order of display, but in this paper, the delivery commission is grades according to phases, terms, expressions used in the headline content, and if it provides a clear delivery to the customer, the commissions is lowered and if it selects ambiguous standard, then the commission will be appropriated highly.

The commissions will be graded according to the detail use model, ordaining various reference model with providing major term, phase and expression. For example, the commission of “discount” and “20% discount” will be earmarked differently.

The personalized specific code can include the delivery code corresponding to the characteristic of user related to delivery of the personalized information. Delivery code can include the location code, the media code and the device code. Examples of elements of location code are office, house, school and on-way. Location code can be acquired from the main terminal(300) or GPS (global positioning system) or MAC (media access control) provided by correlated terminal(400). Examples of media code elements are wired internet and wireless internet. The value of media code can be acquired from the main terminal(300) or correlated terminal(400). Elements of device code can include mobile, PDA, smart-phone, laptop PC and IPTV. The value of media code can be acquired from the main terminal(300) or correlated terminal(400).

The personalized specific code can be set up to have different values for time, location or each terminals. For example, in the afternoon, the element related to the learning development can be set up to have higher value and in the evening, the element related to the mental habit can be set up to have higher value. For another example, in the office, the element related to the work improvement can be set up to have higher value and at home, the element related to the spare time spending can be set up to have higher value. As another example, in case of using portable terminal, the element related to the text can have higher value and in case of using IPTV, the element related to the video clip can be set up to have higher value

Information Specific Code

Information specific code also can include the benefit code, the type code or the delivery code like the personalized specific code. However, the personalized specific code is set up for the user and the information specific code is set up for the information.

Correlation Calculation

The correlation calculation can be performed in various ways. As an example of correlation calculation, the method using the dot product of the personalized specific code and the information specific code is expressed in formula 1. As another example of correlation calculation, there is another method, which outputs the dot product of personalized specific code and the information code as the correlation rate, in case of a value of fixed element of the personalized specific code is that fixed value, if it's not the fixed value, then 0 will be displayed as the correlation rate.

Personalization Configuration Code

Personalization configuration code is the code, which corresponds to the user configuration related to the information pool, the personalized information providing condition, the personalized information providing terminal or the personal menu.

The user can configure the information pool, the personalized information providing condition, the personalized information providing terminal that will be used in the correlation calculation by setting up the personalization configuration code. In detail, the user can set the information pool to be the health related information provided by C company, the personalized information providing condition to be 9 o'clock in every morning and the personalized information providing terminal to be PC, that is correlated terminal located in the office. When the user sets the personalization configuration code in such way, the service providing server(100) selects the personalized information, which will be provided to the user from the health information provided by the C company according to the correlation of the information specific code of health information provided by the C company and the server provides this selected personalized information to the office PC of the user at 9 o'clock in the morning.

The personalized information providing condition does not have to be time and this can be location or many other conditions. For example, when the user connects to the web-server(200), the condition can be set up to provide the personalized information to the user. As another example, if the user terminal is placed within the shopping mall, the condition can be set up to provide the shopping mall-related personalized information to the user. Also, the personalized information providing condition can be set up to follow the lapse of memory method. If the condition is set to follow this method, the service providing server(100) provides the personalized information and after some times (for example, some hours or some days), the server again provides the same information with the personalized information provided before, a summarized information or related information. Such lapse of memory method is essential for the learning (studying) information, which requires review.

The personal menu refers to the set of information pool that will be used in correlation calculation and this includes on-line personal menu (mobile screen, PC screen, IPTV screen, etc) and off-line personal menu (newspaper personal menu, dining-room personal menu, kitchen personal menu, office personal menu, education personal menu, etc). The personalized information providing time and terminal can be set up differently for each information pool included in the personal menu or each personal menu.

Examples of the personal configuration code's detail code are like following.
Personal menu code: Configuration code that corresponds to the personal menu about media, time, terminal, place, etc.
Trust code: Configuration code that corresponds to the characteristic of delivery of personalization information and advertisement defined the boundary of trust deliverying by own. we can configurate lowering delivery trust to have big benefit, or raising delivery trust to have high delivery trust.
Correlation terminal code: The correlation terminal is mentioned as the most utilized personal terminal positioned itself in the places including home, offices, and school. The configuration of the correlation terminal is done with registering of A and B MAC addresses (A MAC address: the MAC address of the wireless access system connecting with the main terminal, B MAC address: the MAC address of the correlation terminal) at the same time in the mainly utilized place.

For example, when the main terminal is wireless LAN Dual phone, the picturing of the code pattern (the code pattern of the correlation terminal MAC address which is provided by the configuration internet site) using the camera of the wireless LAN Dual phone is the registration of A and B MAC addresses (A MAC address: the MAC address of the wireless LAN system connecting with wireless LAN Dual phone, B MAC address: picturing the code pattern of the correlation terminal MAC address) at the same time in the mainly utilized place.
Mainly utilized place code: It is mentioned as the codes that configurate places such as the collective information utilization places like home, or offices, configurating factors can discriminate places as a discriminating factors of related devices with MAC address, or device ID, also it utilizes the discriminating factors of related location with the GPS basis in terms of the extra wireless internet network. In terms of usage, it is used to facilitate terminal relation after using related-code between the two parties, taking an example, if the other party comes to the mainly utilized places, and wants to co-relate and utilize with PC or IPTV, the configuration is finished with taking images of terminal correlation code, and input of mobile phone number is finished, the other party can co-relate with the following terminal and can utilize all of information. Therefore, if the correlation terminal is set-up, it might be utilized as a factor that discriminating the following locations and respective places.
Delivering subject confinement code: It is defined as personalization codes that it confine the configuration about contents that are not safe, not competitive, and not helpful for children. Even if children have already configurated about this code, the parents can except for range of this configuration.
Delivering time confinement code: It is defined as personalization codes that it confine the configuration about delivery time of internet access time, etc.
Limitation confinement code: It is mentioned as a code that configurate various things including limitation confinement of daily or monthly allowed amount after approval, usage limitation of fee, purchase limitation, code-configuration limitation, limitation on additional connection of personalization web pages, limitation on information utilization time-limit, in order to limit the usage range according to the business environment. Not delicately configurating, the information provider can also configurate personalization code with simple inclusion.

Delivery Attribute

For each information pool, scenario-type delivery attribute is applied to improve effect of 24 hours personalized delivery management, which is very different from conventional delivery system. The delivery attribute is another side of personalization configuration code and this corresponds to one of information pool, the personalized information providing condition, the personalized information providing terminal or the personal menu or sets of these. Each information pool creates the personalized delivery attribute of information pool through the selected set of delivery attribute.
Basic delivery attribute: Ordained scenario and ordained information to the user, who selects the target information pool from all kinds of information pool and is the attribute for those should be delivered. Example of ordained information is when the target information pool is charged-information pool and the user uses the miles provided by specific product company to charge, the information that the supporting company must notice the user (written notice, which is used to be delivered through the phone, the letter or the mail, the customer benefit notice, etc) and the image advertisement, the personalized product advertisement exclusively performed within the provided range as a price of supporting.
On-off line related delivery attribute: Attribute of co-relating and delivering the conventional media and on-line media using off-line code in newspaper, book (textbook, magazine, etc), article and others. The user can set up the personal off-line menu in various ways. For example the user can save the code from all kinds of off-line code provided in the paper separately and use this as personalized newspaper off-line menu and print out, and reading the code from the dinning room through the mobile will enable the user to see this personalized information via IPTV. Sticker-type of off-line menu can be used easily by putting it at the office, on the desk, in the bathroom, dining room, kitchen and front door. Especially, it can improve the school education and the company education by personalizing the level and characteristic of the target and apply various level of personalized textbook.
Lapse of memory management delivery attribute: Delivery attribute that is applied to provide efficient personalized management per individual, using the strength of 24 hours personalized delivery management. Attribute, which manages the important things with 2 hours-range memory management, 2 days-range memory management according to the oblivion principle (principle, which states that human forgets the recognized things faster after 20 minutes and within 2 hours and remember only 20-30% of initial recognized things).
Rule of 8020 delivery attribute: To improve the effect of lapse of memory management delivery attribute, delivery 20% of information to keep 80% effect of the first delivery at the second delivery for the lapse of memory management. For example, to decrease deterioration value for personalized information, deliver the major delivery information of 8020 effect of the major topic for each 2 hours or 2 days after delivering the personalized information. In traditional independent media, such attribute cannot be satisfied.
Knowledge delivery attribute: Attribute of detailed category of personalization knowledge information.

Mental habit developing attribute is delivery attribute of increasing mental habit. it is consist of delivery attribute of decreasing the aggravated value, delivery attribute of increasing the elevated value, delivery attribute of increasing executive ability.

Both Factor X and Factor Y belong to the factors that are concerned with individual mental habit, therefore they are mentioned as the decided factors that depends on two causes and nearly forms the frameworks with them: home surroundings before forming prior to the age of fifteen, and parents' acquired mental habit. And once formed, it is acutely difficult to after the framework with their own recognization and much trial. Therefore, most of people connect either factors with religious life to improve them. However religious they may be, it could be mentioned as the main characteristics that incorrectly-formed mental habit in the childhood cannot be revised. Whatever they tries to improve them with preach, worship, praying, and lives of zen, it is hard to get accustomed to the right essentials of spirit by human forgetting. As human characteristics, however people obtain essentials of solution and good-will, most of them forget about them within one or two days or so, eventually they live up to comply with the existing habit. In the end, if someone constructs the framework of incorrect mental-habit, they had no choice but to face with their lives on the basis of tangled-up ideas and poor performances, so they may not succeed in and connect them with good results. It could not be a difficult process however inefficient their deep-rooted recognization and its own reflection, but be a commonplace stance with laziness when forgetting intervenes their behavior with the passage of time, since there is no suitable tools to correct its fatal problems. How the realization is performed within human forgetting, a certain person forgets most about something meaningful within the passages of from twenty minutes, if time passes two hours, since he or she only remembers something with the proportions of thirty percent, individually personalization programs are needed for people to maintains their own realization and self-reflection.

It is also needed to construct individually personalization management programs to focus on twenty-percent of a certain trial showing eighty percent of their own competitiveness. In this invention, the efficient methods will be provided in order to accordingly and effectively develop their own mental-habit & capacities. To enhance individual competitiveness and life-qualities in the near future, there are two curriculums including basic personalization development process of mental habit & competence, and advanced personalization development process of mental habit & competence to satisfy with specifically various needs. The advanced personalization development process of mental habit & competence applies the basic courses which mentioned above basically, and connects and utilizes it according to the specific purposes. The development course of mental capacity was invented in order to improve individual mental capacity effectively in the wired or wireless total convergence environment.

The features of development factors of mental-habit can be described with the seven conceptual figures including standard value, superior-above-standard value, inferior-below-standard value, elevated value, aggravated value, capacity value, and critical value. The standard value is defined as the relative conceptual value that expresses the individually existed mental-habit capacity, it is represented by a way of difference between superior-above-standard value and inferior-below-standard value, individually typical mental-habit capacity can be expressed as conceptual value of area that standard values of both Factor X and Y reaches. Elevated value and aggravated value is mentioned as the value of mental habit capacity that shows static change by certain causes, aggravated value can be mentioned as mental energy that changes the superior-above-standard value, and aggravated value is mentioned as the conceptual value that alters inferior-above-standard value. To enhance mental-habit & capacity, the capacity value should be go up with capacity difference, deriving from a phenomena that elevated value should be maintained higher than standard value, at the same time, aggravated value should be maintained lower than standard value. Additionally, the critical value is the mentioned as zero value that there is no difference between elevated value and the aggravated value.

Factor X is related with development factor that the entire mood and static change determines the long-term framework of its own, and since it affects the rest of two factors, the development factors of Factor Y, and Z should be deteriorated if the conditions of X development factors undergo bad. Moreover, since its undulation can be relatively changeable according to its own environment or stimulation, it is that factor that should be taken care of most delicately in a well-organized manner.

Since Factor Y is affected by the condition of Factor X directly, it has less static undulation than ups-and-downs of Factor X capacity value, in short, it is a gradually changing factors. Factor Z is influenced by the state of Factor X and Factor Y indirectly, even if the state of Factor X and Factor Y underwent unsuitable state, it has relatively low ups-and-down, unless it is not developed cooperatively in a well-organized manner on the stable basis of Factor X and Factor Y, it is not effective and cannot be maintained however it develops various Factor Z. Factor Z is related to knowledge capacity, therefore it is developed by a choice of two groups including personal tastes like interested-field, major, and hobby, and means of the need.

Elevated value and aggravated value of Factor X belongs to the value that reveals the static change by two causes including sentiments or health problems in the short-term, therefore if the elevated value of Factor X goes up, it is mentioned as the conceptions that increases superior-above-standard value and makes mental energy efficient including passion, desire, self-confidence, pleasure, and healthy state, meanwhile, if the aggravated value goes down, it is mentioned as the conceptions that decreases inferior-below-standard value and makes such mental energy distinct including thankfulness, humbleness, good sentiment, open minds-set.

Since elevated value and aggravated value of Factor Y demonstrates their own ups-and-downs by mostly the reason, rational thinking, logical thinking, action, and performance, if the elevated value of Factor Y goes up, it means that superior-above-standard value increases, action, performance, and concentration make mental energy strong, the aggravated value of Factor Y goes down, it means that inferior-below-standard value decreases, dimensional recognization, insightful vision, and wise choice make mental energy better and strong.

With consideration of human qualities, If the elevated value of Factor X goes up, naturally arrogance, and overweight desire arises from inner vision, eventually since the aggravated value of Factor X goes up, it will be required to construct methodological approach to make up of humbleness and open mind set with external support and reduced aggravated value. In addition, in case of minimization of the elevated value of annoyance, anger, and abandonment consciousness in consideration with human characteristics increases automatically, Such methodological approaches like either controlling the cause of increased elevated value or decreasing the aggravated value with external support, thereby constructing inner vision of humble and open mind-set. And if the elevated value is low, the aggravated value is high, and therefore the value reaches the critical value, it is possible to construct basis for returning naturally low elevated value back to the regular state.

When it is assumed that if the elevated value is much higher than superior-above-standard value and the aggravated value is high, and the capacity value of factor X identically have the value as A since the elevated value has as the similar value as superior-above-standard value or the aggravated value is so low, the aggravated value of X factor remaining low reveals a good condition in order to keep the capacity value more efficient, even with externally environmental stimulation. If a certain condition belongs to the state that critical value positions itself as high, it can make much undulation by stimulants or environment. therefore it can reaches the critical value more easily than it was expected. Therefore, it is important to maintain the aggravated value as low. In addition, if it goes over the critical value since it is not controlled well, it becomes the state of sentimentally overweight surplus, once it reaches such condition, it forms vicious circle of making sentimental explosion again even with a little stimulation, therefore, to manage the aggravated value stably and typically is more important than anything else. The critical value of Factor X reaches, since it is easy to leave big side effects, however capable he or she is, and eventually it is likely to have little choice but to face with fatal situation, it is important to control it delicately in a typical life.

The increase of the aggravated value of Factor X affects the increase of the aggravated value directly, and the aggravated value of Factor X becomes low, the aggravated value of Factor Y becomes low automatically. Therefore, since the trial to individually reduce only the aggravated value of Factor Y is ineffective compared to the quantitative amount of the trial, correlation with the management of the aggravated value of Factor X can naturally reduces the aggravated value down. As a matter of fact, if in a mentally bad state individually, even if it seems that it is difficult to realize his or herself and control his or herself, the tangled-up problems will be gone away if individually effective methods are mixed up with the following information utilization of this invention.

A person experiences lethal failure or mistakes that a feat can be derided, as time passes, in this case, a person recognizes that he or she could not unravel the undoubtedly simple problems with over-fixation of incorrect habit. These mistakes can be repeated again mostly with similar reasons, so even if it is not corrected fully, the doom for him or her cannot be recovered.
Delivery attribute of decreasing the aggravated value: personalization development topics for decreasing the aggravated value of Factor X: thanking, being humble, not to be arrogant, being comfortable, making open mind-set, making rooms for the rest of life.

personalization development topics for decreasing the aggravated value of Factor Y: diminishing bias, throwing the red-type away, making trial
Delivery attribute of increasing the elevated value: personalization development process of increasing the elevated value of Factor Y is provided as below.

personalization development topics for recovering self-passion:

being self-confident, doing it on his or her own, challenging toward the target

personalization development topics for recovering self-strength:

Recovering self-positive sentiment, finding own talents

personalization development topics for health-management:

Recovering health in a personalization manner, Exercising in a personalization manner

personalization topics for developing pleasure and enjoyment:

Personally personalization humor, interest, and abundance.

personalization process for developing the capacity value enhancement of factor Y can be provided according to the following topics.

personalization process for developing the capacity value enhancement of factor Y can be provided according to the following topics.

personalization topics for right thinking and action: honesty, keeping the promise, keeping the rule, and keeping the plan straight.

Personalization topics for performing wise thinking: Making wise choice, multi-dimensional reflection, concentration, endowing the priority from the most important to the least important, making creative ideas, preventing something unfortunate, learning form the failure, making economic mind-set.

personalization-made topics for keeping good human relationship: Making consideration, making lots of complimentary comments, satisfying with mutual benefit, having abundance and great humor.
Delivery attribute of increasing executive ability: This delivery attribute is personalized recognition message type delivery attribute.

Using personalization information about delivery attribute of decreasing the aggravated value and delivery attribute of increasing the elevated value, the customer increase executive ability of his execution. Main delivery subject is making wise choice, over-fixation of incorrect habit, etc.

The user can set up the personalization configuration code using the main terminal(300) or correlated terminal(400) and the information related to this can be transmitted to the service providing server(100) through the network(500) and can also be transmitted passing through the web-server(200).

The personalization configuration code can be changed according to the response of user. For example, the information pool with low response for a long-term can be deleted from the personal menu.

Off-Line Code

Off-line code is the one provided in a form of image, sound or signal from external of terminal. Examples of off-line code are the code with printed pattern like bar-code or the code delivered as wired and wireless signal like RFID. Off-line code can be provided through various media. For example, the off-line code picks up the image by the mobile camera and codes and various off-line codes can be provided through the printed code-book and the code displayed on the monitory. As another example, the off-line code can be provided with advertisement or article on a newspaper, magazine or pamphlets. In personalized service, the off-line code can be used in various ways. As an example of application of off-line code, the off-line can be used in the personalized specific code or the personalization configuration code setting. In detail, the user can set up the position as a director from the type code by scanning the code, which corresponds to a director from several off-line codes included in the code book. Also, the user can set up the personalized information providing time as 6 o'clock in the afternoon from the type code by scanning the code, which corresponds to 6 o'clock in the afternoon from several off-line codes included in the codebook. For other application of off-line code, the off-line code can be used to request for the personalized information. In detail, the user can request to provide the personalized information to the service providing server(100) by scanning the off-line code placed in the clothes advertisement of D company printed in the magazine. In this case, the service providing server(100) selects the clothes related information provided by D company from the off-line code pattern delivered with the request for the personalized information and chooses the personalized information according to the correlation between the information specific codes and the personal specific code included in selected information pool and provide this selected personalized information to the user.

On-Line Code

On-line code is configured as the user inputs or selects through the user interface of terminal. The web-server(200) can acquire this on-line code information from the terminal and deliver it to the service providing server(100) and the terminal can also deliver the on-line code information to the service providing server(100) directly.

In personalized service, the on-line code can be used in various ways. For instance, the on-line can be used to set up the personalized specific code or the personalization configuration code like off-line code. As another example, the on-line code also can be used to request for the personalized information. In detail, the user can request for the personalized information to the service providing server(100) by inserting the searching word (for example, restaurant) in the searching window. In this case, the service providing server(100) selects the information (for example, good Chinese food restaurant, good Korean food restaurant, good Western food restaurant) acquired from searching information corresponds to the searching word (for example, good food restaurant) that is delivered with the request for the personalized information as the information pool and select the personalized information (for example, good Korean food restaurant) in accordance of the correlation between the information specific code of information included in selected information pool and the personalized specific code (for example: [Chinese food, Korean food, Western food]=[0, 2, 0]) and provides this selected personalized information to the user.

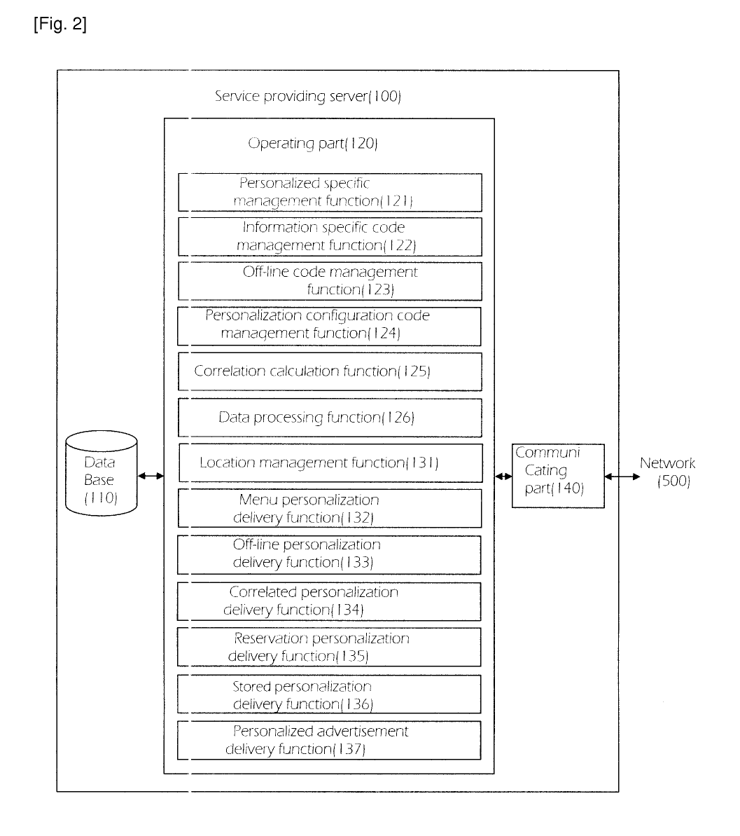

FIG. 2 shows the example of the service providing server(100) applied in the personalized information service system in FIG. 1. According to FIG. 2, the service providing server(100) includes database(110), operating part(120) and communicating part(140).

Database(110) stores all kinds of information required to operate the service providing server(100). Database(110) stores the personalized specific code of users, the location information and the information specific codes of information. Database(110) can store more data provided by the information provider. Database(110) can store more personalization configuration information of users. Database(110) can store more off-line codes and the table saving the meanings that off-line codes refer (for example, the off-line code of 0011 can refer to the request of selecting and providing the personalized information from the clothes-related information provided by D company).

Operating part(120) performs the personalized specific management function(121), the information specific code management function(122), the off-line code management function(123), and the personalization configuration management function(124), the correlation calculation function(125) and the data processing function(126).

The personalized specific management function(121) includes a function of changing the beneficial code according to miles, points provided by the affiliated company, function of changing the type code according to response level of user or configuration of user and function of changing the delivery code in accordance of user's location, the type of using terminal or the type of media that the terminal uses.

The information specific code management function(122) can include a function of saving the contents provided by the information provider or the beneficial code of advertisement, the type code or the delivery code.

The off-line code management function(123) can includes a function of managing the off-line codes and the table with meanings of these codes.

The personalization configuration code management function(124) can include a function of saving and modifying the information pool, the personalized information providing condition, the personalized information providing terminal or the personal menu.

The correlation calculation function(125) refers the calculation of correlation between the personalized specific code and the information specific code.

Data processing function(126) includes a function of selecting the information that will be used in correlation calculation according to on-line code, off-line code and personalization configuration code and function of providing the selected personalized information to appropriate terminal (the personalized information providing terminal stored in database(110), the main terminal(300) or correlated terminal(400), which requests the information, or the terminal that is indicated by the main terminal(300) or correlated terminal(400)) at proper time (according to the personalized information providing condition stored in database(110), or instantly for the request of the main terminal(300) or correlated terminal(400)). In case of the main terminal(300) or correlated terminal(400) not having the decoder, which decodes the off-line code pattern, the operating part(120) can add the function of decoding the delivered off-line code pattern from the main terminal(300) or correlated terminal(400).

The operating part can perform the location management function(131), the menu personalization delivery function(132), the off-line personalization delivery function(133), the correlated personalization delivery function(134), the reservation personalization delivery function(135), the store personalization delivery function(136), and the personalized advertisement delivery function(137) in addition.

This location management function(131) manages the location of individual and performs a function of selecting the personalization delivery terminal per location or personal menu per location, referring to the data (wireless transmitter at target location or MAC ID of wireless LAN, or special location data, etc), which classifies the personal application location stored in database(110). This menu personalization delivery function(132) is in charge of delivering the personalized information according to the personal menu of the personalization configuration code and this processes the personalized delivery to the personal menu correlated to the location management function(131), which manages the personal location, in case of receiving the request message regarding menu personalization delivery of the customer terminal (mobile, PC, IPTV, etc) or delivering according to the process, configured by the menu personalization delivery scheduler. In case of receiving the off-line code personalization delivery, this off-line personalization function(133) selects and delivers the terminal, correlated to the location management function, which manages the personal location when it is needed. In case of receiving the correlated personalization delivery, this correlated personalization delivery function(134) delivers the terminal, which should be delivered to the user, to the target terminal, correlated to the location management function, which manages the personal location when it is needed.

When this reservation personalization delivery function(135) processes the reservation personalization delivery, this confirms whether the user is moved to appointed place and delivers the personalized information to the terminal at appointed location in the same course of processing the correlated personalization delivery.

When this store personalization delivery function(136) processes the store personalization delivery, it selects the terminal, which should be performed the store personalization delivery function and performs the personalization delivery under the supporting of the location management function(131) if it's necessary.

The store personalization delivery scheduler delivers and processes the target store personalization information as the personal menu of the customer terminal, when the user is at the main application location and is under a periodic store delivery schedule.

This personalized advertisement processes the delivery of personalized advertisement included in all kinds of personalized information per user. The content of personalized advertisement included in the personalized information will be delivered differently per individual, even thought it's same personalized information delivery.

The communicating part performs the communication with the main terminal(300), the correlated terminal(400) or the web-server(200) through the network(500).

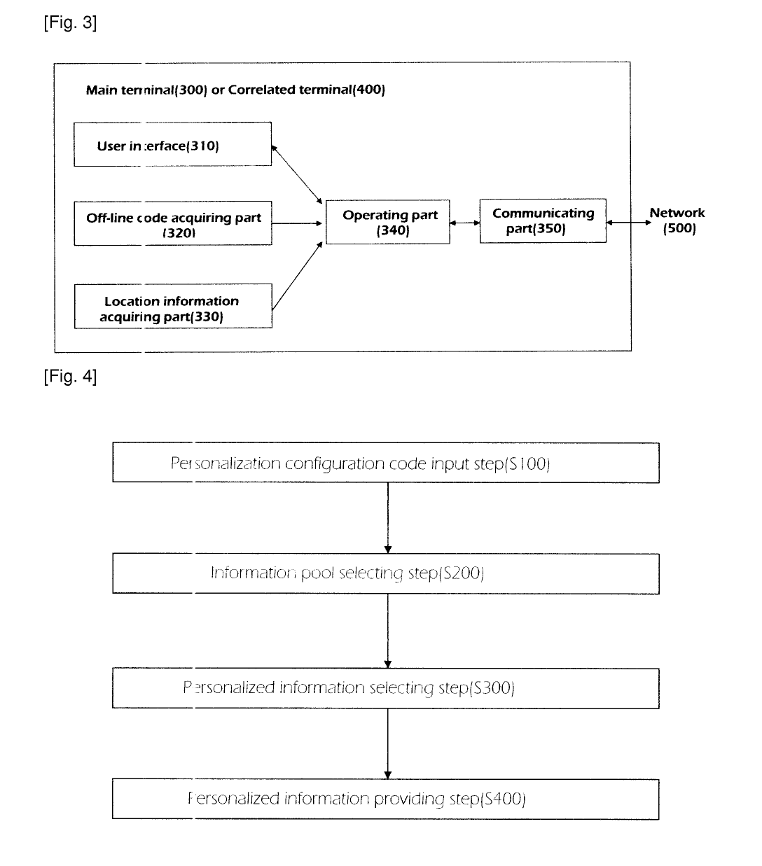

FIG. 3 shows the main terminal(300) or correlated terminal(400) applied in the personalized service system in FIG. 1. Referring to FIG. 3, the main terminal(300) or the correlated terminal(400) includes the user interface(310), the off-line code acquiring part(320), the location information acquiring part(330), the operating part(340) and the communicating part(350).

The user interface(310) is the part providing the interface between the user and the terminal, and through this part, input of on-line code, configuration of beneficial code, or configuration of personalization configuration code can be performed. Also, the personalized information provided by the service providing server(100) can be displayed via the user interface(310). The off-line code acquiring part(320) performs a function of acquiring the off-line code pattern. Examples of off-line code acquiring part(320) are digital camera, scanner, or RFID reader.

The location information acquiring part(330) performs a function of acquiring GPS information or MAC address. Example of location information acquiring part(330) can be GPS receiver.

The operating part(340) delivers the information gained from the user interface(310), the off-line code acquiring part(320) or the location information acquiring part(330) to the communicating part(350) and delivers the personalized information provided by the communicating part(350) to the user interface(310). Also, this operating part (340) can perform decoding function, which interprets the off-line code pattern gained from the off-line code acquiring part(320) and abstracts the off-line code.

The communicating part(350) performs communication with the web-server(200) or the service providing server(100) through the network(500).

FIG. 4 shows the method of personalized service through an operational example. Referring to FIG. 4, the personalized information service method includes the personalized information selecting step(S300) and the personalized information providing step(S400).

In the personalized information selecting step(S300), the service providing server(100) selects the personalized information, which will be provided to the user according to the correlation between the information specific code corresponding to the characteristic of information and the personalized specific code corresponding to the characteristic of user.

In the personalized information providing step(S400), the selected information is provided to the user's terminal. The user's terminal, where the selected information is provided can be the personalized information providing terminal, configured in the personalized information selecting step(S300). Also, the user's terminal, where the selected information is provided can be the terminal, which has requested for the personalized information. The terminal can request for the personalized information and at the same time, it can provide the off-line code, off-line code pattern or on-line code. Moreover, the user's terminal, where the selected information is provided can be the terminal indicated by the user, who has requested for the personalized information.

The personalized information service method can also have the personalization configuration code input step(S100) and the information pool selecting step(S200).

In the personalization configuration code input step(S100) the user can configure the information pool, the personalized information providing condition, the personalized information providing terminal or the personal menu. In case of the personalized information providing condition is configured, the personalized information providing step(S400) can be performed only after the configured condition is satisfied. Also, In case of the personalized information providing terminal is configured, the personalized information will be provided to the configured personalized information providing terminal in performing the personalized information providing step(S400).

In the information pool selecting step(S200), the service providing server(100) selects the information pool, which will be used in the correlation calculation.

### INDUSTRIAL APPLICABILITY

As the personalized information service system and the method via this invention provides the selected information according to the correlation between the personalized specific code and the information specific code, it has a strong point of providing the information that is either essential or interested to the user, in aspects of user. Also, an individual can co-relate the most familiar on-off media into one personal menu and use the personalization integrated information channel and the personalized advertisement channel that the user can configure the reliability level by oneself for a long-period.

Moreover, as the personalized information service system and the method provides the information according to the correlation between the personalized specific code and the information specific code, it has an advantage of providing the information to the user, who has huge probability to use the information, in aspects of the information provider (for example, the content provider, or the advertisement provider).

The personalized information service system and the method via this invention can be applied to various application such as education, advertisement, search.

The information pool can be selected through various methods. For instance, in case of off-line code or off-line code pattern is provided from the terminal(300 or 400), the information pool corresponding to the off-line code can be selected to be used in the correlation calculation. As another example, when the on-line code is provided to the web-server(200), the information pool corresponding to the on-line code can be selected to be used in the correlation calculation. For another example, the information pool configured in the personalization configuration code can be selected to be used in the correlation calculation.

1-43. (canceled)

44. A personalized service system, comprising:
a service providing server selecting personalized information to be provided to a user depending on a correlation between a personalized specific code corresponding to the user's characteristics and an information specific code corresponding to a characteristic of each piece of information; and
a user terminal receiving the selected personalized information.

45. The system of claim 44, wherein the service providing server selects the personalized information from pieces of information included in an information pool selected by the user depending on the correlation.

46. The system of claim 44, wherein the personalized specific code includes a beneficial code corresponding to the user's characteristics related to benefits with which companies provide the user.

47. The system of claim 44, wherein the personalized specific code includes a type code related to information types.

48. The system of claim 47, wherein the type code includes at least one of a mental-habit developing code, a learning attitude developing code, a learning ability developing code, a religious belief strengthening code, a health care code, a financial technology code, a spare-time activity code, a life-essential information code, a discount benefit code, a company supply code and an individualized advertisement code.

49. The system of claim 47, wherein the type code is settable by the user.

50. The system of claim 47, wherein the type code is changeable depending on a degree of the user's response to the provided information.

51. The system of claim 44, wherein the personalized specific code includes a delivery code corresponding to the user's characteristics related to delivery of information.

52. The system of claim 44, wherein the personalized specific code has a separate value according to time, location or the user terminal.

53. The system of claim 44, wherein the service providing server selects the pieces of information to be used for calculating the correlation according to off-line code information provided by the user terminal or an additional terminal.

54. The system of claim 44, wherein the service providing server selects the pieces of information to be used for calculating the correlation according to on-line code information provided by the user terminal or an additional terminal.

55. The system of claim 44, wherein the service providing server operates according to a personalization configuration code set up by the user, the personalization configuration code including configuration information on at least one of an information pool, a personalized information providing condition and a personalized information providing terminal.

56. The system of claim 55, wherein the service providing server uses information included in the information pool to calculate the correlation.

57. The system of claim 55, wherein the service providing server provides the personalized information to the user terminal when the personalized information providing condition is satisfied.

58. The system of claim 55, wherein the service providing server provides the personalized information to the user terminal corresponding to the personalized information providing terminal.

59. The system of claim 55, wherein the personalization configuration code is set up depending on off-line code information provided by the user terminal or an additional terminal.

60. The system of claim 55, wherein the information pool used by the service providing server is configured according to a delivery scenario using at least one of a basic delivery attribute, an on-off line related delivery attribute, a lapse of memory management delivery attribute, a rule of 8020 delivery attribute, a deterioration value decreasing delivery attribute, an improvement value increasing delivery attribute, an execution reinforcing delivery attribute, and an information-made delivery attribute.

61. The system of claim 44, wherein the service providing server operates according to a personalization configuration code set up by the user, the personalization configuration code including configuration information on at least one of a personal menu code, a delivery reliable code, a main correlated terminal code, a main application place code, a transmitting area limitation code, a transmitting time limitation code and a limit restriction code.

62. The system of claim 44, wherein the pieces of information include an advertisement.

63. A personalized service method, comprising:
selecting personalized information to be provided to a user depending on a correlation between a personalized specific code corresponding to the user's characteristics and an information specific code corresponding to a characteristic of each piece of information; and
transmitting the selected personalized information to the user's terminal.

64. The method of claim 63, wherein selecting personalized information includes selecting, at the service providing server, the personalized information from pieces of information included in an information pool selected by the user depending on the correlation.

65. The method of claim 63, wherein transmitting the selected personalized information includes transmitting the selected personalized information to the user terminal according to at least one method of personalized menu delivery, off-line delivery, correlated delivery, store-made delivery and advertisement delivery.

66. The method of claim 63, wherein the personalized specific code includes a beneficial code corresponding to the user's characteristics related to benefits provided by companies.

67. The method of claim 63, wherein the personalized specific code includes a type code corresponding to the user's characteristics related to information types.

68. The method of claim 67, wherein the type code includes at least one of a mental-habit developing code, a learning attitude developing code, a learning ability developing code, a religious belief strengthening code, a health care code, a financial technology code, a spare-time activity code, a life-essential information code, a discount benefit code, a company supply code and an individualized advertisement code.

69. The method of claim 67, wherein the type code is settable by the user.

70. The method of claim 67, wherein the type code is changeable depending on a degree of the user's response to the provided information.

71. The method of claim 63, wherein the personalized specific code includes a delivery code corresponding to the user's characteristics related to delivery of information.

72. The method of claim 63, wherein the personalized specific code has a separate value according to time, location or the terminal used in transmitting the selected personalized information.

73. The method of claim 63, further comprising selecting the pieces of information to be used for calculating the correlation according to off-line code information provided by the user's terminal or an additional terminal.

74. The method of claim 63, further comprising selecting the pieces of information to be used for calculating the correlation according to on-line code information provided by the user's terminal or an additional terminal.

75. The method of claim 63, further comprising setting up a personalization configuration code including configuration information on at least one of an information pool, a personalized information providing condition and a personalized information providing terminal.

76. The method of claim 75, further comprising selecting the configuration information on the information pool as the pieces of information to be used for calculating the correlation.

77. The method of claim 75, wherein transmitting the selected personalized information is performed when the personalized information providing condition is satisfied.

78. The method of claim 75, wherein transmitting the selected personalized information includes providing the personalized information to the user's terminal corresponding to the personalized information providing terminal.

79. The method of claim 75, wherein the personalization configuration code is set up depending on off-line code information provided by the user's terminal or an additional terminal.

80. The method of claim 75, wherein the information pool is configured according to a delivery scenario using at least one of a basic delivery attribute, an on-off line related delivery attribute, a lapse of memory management delivery attribute, a rule of 8020 delivery attribute, a deterioration value decreasing delivery attribute, an improvement value increasing delivery attribute, an execution reinforcing delivery attribute, and an information-made delivery attribute.

81. The method of claim 63, further comprising setting up a personalization configuration code including configuration information on at least one of a personal menu code, a delivery reliable code, a main correlated terminal code, a main application place code, a transmitting area limitation code, a transmitting time limitation code and a limit restriction code.

82. The method of claim 63, wherein the pieces of information include an advertisement, and the personalized information includes a personalized advertisement.

83. The method of claim 82, wherein the personalized advertisement is provided according to keyword searching in order of high correlation between an information specific code of the advertisement and the personalized specific code of the user.

84. The method of claim 82, wherein an advertisement commission is differentially applied according to individual application responses of persons provided with the personalized advertisement.

85. The method of claim 82, wherein an advertisement commission is differentially applied according to phrases or expressions used in a headline title.

86. The method of claim 63, further comprising link registering a media access control (MAC) address of a wireless transceiver connected to a main terminal in a main application location and a MAC address of a correlated terminal such that the main terminal is in communication with the correlated terminal,
wherein the main terminal is carried by the user,
the correlated terminal is placed in the main application location of the user, and
at least one of the main terminal and the correlated terminal corresponds to the terminal to which the personalized information is transmitted.
